(19) United States
(12) Patent Application Publication
(10) Pub. No.: US 2014/0219314 A1
(43) Pub. Date: Aug. 7, 2014

(54) NON-CONTACT TEMPERATURE MONITORING DEVICE

(71) Applicant: Deog Bong Ryou, Gyeonggi-do (KR)

(72) Inventor: Deog Bong Ryou, Gyeonggi-do (KR)

(21) Appl. No.: 14/343,387

(22) PCT Filed: Sep. 7, 2012
(86) PCT No.: PCT/KR2012/007215

§ 371 Date: Mar. 6, 2014

(30) Foreign Application Priority Data
Sep. 8, 2011 (KR) 10-2011-0091407

(51) Int. Cl. G01K 13/00

(52) U.S. Cl. CPC G01K 13/00
USPC 374/152

(57) ABSTRACT

The present invention pertains to a non-contact temperature monitoring device, wherein: temperature data and image data are simultaneously outputted to a monitoring unit by simultaneously photographing a temperature detection target and detecting the temperature of the temperature detection target in a non-contact manner, in which the temperature state of the temperature detection target and on-site conditions can be monitored in real time; the state of the temperature detection target is photographed using an image capturing unit only when the temperature state of the temperature detection target is abnormal, thereby simplifying an operation in a normal state and more accurately detecting on-site conditions using image information in emergency situations. Accordingly, quicker and more accurate responses are possible, thereby preventing fire accidents in industrial settings.

### CROSS-REFERENCE TO RELATED APPLICATION

This application claims the benefit of Korean Patent Application No. 10-2011-0091407, filed on Sep. 8, 2011 in the Korean Intellectual Property Office, the disclosure of which is incorporated herein by reference.

### TECHNICAL FIELD

The present invention relates to a non-contact temperature monitoring device. More particularly, the present invention relates to a non-contact temperature monitoring device that can monitor a temperature state and a field situation of a temperature detection object in real time by enabling to simultaneously output temperature data and image data to a monitoring unit by detecting a temperature of the temperature detection object with a non-contact method while photographing the temperature detection object and that can simplify operation in a normal state by enabling to photograph a state of a temperature detection object through an image photographing unit only when an abnormal situation occurs in a temperature state of the temperature detection object and that can grasp more accurately a field situation through image information in an urgent situation and thus a more quick and accurate action can be performed, thereby previously preventing a fire accident in an industrial field.

### BACKGROUND ART

In general, an electric component has a characteristic that emits a heat by electric resistance, and such heat generation damages an electric component and may occur a fire and thus by accurately measuring and grasping a heat generation state of the electric component, it is very important to previously prevent a large accident.

Particularly, in an industry field, in an electric component that supplies a large amount of electricity, due to heat generation, the frequency of electric component damage and fire occurrence is very high, and in this case, operation of a production facility is stopped or due to a fire, large damage may occur and thus in an industry field, a temperature monitoring device of such an electric component is essential.

For example, for operation or the control of a power plant and a substation and for operation of a motor, a switchboard in which a switch, a meter, and a relay are installed is installed, and in a large scale factory, various kinds of switchboard boxes such as a Programmable Logic Control (PLC) panel, a high-low pressure panel, a repair panel, an extra-high voltage incoming panel, and a communication system panel are used. In a large scale plant, in a switchboard in which a load greatly applies, in an electric wire or an electrical contact region, due to resistance increase, a high heat occurs and thus in such a switchboard, a temperature monitoring device that can always monitor an inside temperature is installed.

As such a temperature monitoring device, a temperature detector of a non-contact method is generally used, and a non-contact temperature detector of the conventional art mounts a plurality of infrared ray sensors toward a plurality of specific points to detect a temperature, and the non-contact temperature detector is formed with a method of measuring a temperature of each point through the plurality of infrared ray sensors or a method of installing a thermal image camera that can photograph an entire area temperature of a temperature detection object.

When using a plurality of infrared ray sensors, an installation work thereof is difficult and a plurality of electric wires should be connected and thus such a non-contact temperature detector has a complicated structure and maintenance thereof is difficult. Further, because a thermal image camera visually provides a relative temperature distribution of a photographing entire area, it is difficult to instantaneously grasp temperature information of a specific point, and due to a structure that cannot detect a temperature by designating only a specific point, a temperature is detected in an entire area including an unnecessary area and thus it is very inefficient in view of efficiency and a cost is expensive and thus there is a problem that the non-contact temperature detector is not widely applied in an industry field.

Particularly, because a temperature monitoring device of the conventional art simply detects only a temperature, in a state in which a temperature of a temperature detection object is considerably high, a worker cannot know an actual field situation, and only when the worker directly moves to a field, the worker can grasp a field situation and thus the worker cannot directly check fire danger of the field, whereby there is a limitation in taking an appropriate prevention action in a urgent situation.

### DETAILED DESCRIPTION OF INVENTION

### Technical Problem

The present invention has been made in view of the above problems, and provides a non-contact temperature monitoring device that can monitor a temperature state and a field situation of a temperature detection object in real time by enabling to simultaneously output temperature data and image data to a monitoring unit by detecting a temperature of the temperature detection object with a non-contact method while photographing the temperature detection object.

The present invention further provides a non-contact temperature monitoring device that can simplify operation in a normal state by enabling to photograph a state of a temperature detection object through an image photographing unit only when an abnormal situation occurs in a temperature state of the temperature detection object and that can grasp more accurately a field situation through image information in an urgent situation and that can take thus more quick and accurate action.

The present invention further provides a non-contact temperature monitoring device that can more stably and efficiently measure and monitor a temperature of a temperature detection object through a non-contact temperature detection unit of a simple structure that can detect a temperature of a relatively wide temperature detection area through a camera method structure and that can simultaneously detect a temperature of a plurality of specific points by setting only a specific point within a temperature detection area.

### Technical Solution

In accordance with an aspect of the present invention, a non-contact temperature monitoring device, includes: a non-contact temperature detection unit that detects a temperature of a plurality of points of a temperature detection object with a non-contact method; a sensing unit that includes an image photographing unit that photographs the temperature detection object; a data transmitting unit that is connected to the sensing unit to transmit temperature data and image data obtained by the sensing unit; a monitoring unit that receives and outputs temperature data and image data obtained by the sensing unit; and a controller that receives the temperature data and the image data from the data transmitting unit to apply the temperature data and the image data to the monitoring unit.

Preferably, the non-contact temperature monitoring device further includes a manipulating unit to be manipulated by a user so as to select an operation state of the image photographing unit, wherein the controller controls an operation state of the image photographing unit according to a manipulating signal of the manipulating unit.

Preferably, the controller controls an operation state of the image photographing unit according to temperature data obtained by the non-contact temperature detection unit.

Preferably, if temperature data obtained by the non-contact temperature detection unit is equal to or larger than a preset reference value, the controller controls the image photographing unit to photograph the temperature detection object.

Preferably, the sensing unit and a data transmitting unit corresponding thereto are each provided in plural, and the controller controls to alternately output temperature data of a plurality of sensing units to the monitoring unit.

Preferably, if one temperature data of temperature data of the plurality of sensing units is equal to or larger than a preset reference value, the controller controls an image photographing unit of a corresponding sensing unit to operate and controls temperature data and image data of a corresponding sensing unit to intensively output to the monitoring unit.

Preferably, the monitoring unit includes: a display unit that displays temperature data and image data received from the controller; and a warning device that can warn a state of temperature data received from the controller, wherein the controller controls the warning device to operate, if temperature data is equal to or larger than a preset reference value.

Preferably, the non-contact temperature detection unit and the image photographing unit of the sensing unit are fixed and coupled to one case so as to fix a relative position.

Preferably, the non-contact temperature detection unit detects a temperature of a plurality of points within an area photographed by the image photographing unit.

Preferably, the non-contact temperature detection unit includes: a printed circuit board (PCB) that is disposed within the case and that has a light receiving area at one side; a lens module that collects infrared rays generated in the temperature detection object and that is mounted to protrude to a front side surface of the case so as to apply the infrared rays to the light receiving area; an infrared ray sensor chip that is mounted in plural in the light receiving area so as to receive infrared rays and that receives infrared rays to convert the infrared rays to an electric signal; and a calculation unit that receives and calculates an electric signal of the infrared ray sensor chip to generate each temperature data, wherein a temperature of a plurality of points of the temperature detection object is detected through a plurality of infrared ray sensor chips.

Preferably, the image photographing unit includes: a camera that is coupled to the case to photograph the temperature detection object; and a lighting lamp that is coupled to the case to radiate lighting light to the front side of the camera, wherein the controller controls the camera and the lighting lamp to operate.

Preferably, the infrared ray sensor chip is disposed in a specific arrangement state in the light receiving area so as to detect a temperature of a specific point of the temperature detection object.

Preferably, the infrared ray sensor chip is evenly disposed in an entire area of the light receiving area, and only a specific infrared ray sensor chip of a plurality of infrared ray sensor chips is activated to detect only a temperature of a specific point of the temperature detection object.

### Advantageous Effects

According to the present invention, by detecting a temperature of a temperature detection object with a non-contact method while photographing the temperature detection object and by enabling to simultaneously output temperature data and image data to a monitoring unit, a temperature state and a field situation of the temperature detection object can be monitored in real time.

Further, only when an abnormal situation occurs in a temperature state of a temperature detection object, by enabling to photograph a state of the temperature detection object through an image photographing unit, operation can be simplified in a normal state, and in a urgent situation, a field situation can be more accurately grasped through image information and thus by taking a more quick and accurate action, a fire accident in an industrial field can be previously prevented.

Further, a temperature of a temperature detection area of a relatively wide size can be detected through a structure of a camera method, and by setting only a specific point within a temperature detection area, a temperature of a temperature detection object can be more stably and efficiently measured and monitored through a non-contact temperature detection unit of a simple structure that can simultaneously detect a temperature of a plurality of specific points.

### BRIEF DESCRIPTION OF DRAWINGS

FIG. 1 is a block diagram illustrating a configuration of a non-contact temperature monitoring device according to an exemplary embodiment of the present invention;

FIG. 2 is a block diagram illustrating a configuration of another form of a non-contact temperature monitoring device according to an exemplary embodiment of the present invention;

FIG. 3 is a perspective view illustrating a shape of a sensing unit of a non-contact temperature monitoring device according to an exemplary embodiment of the present invention;

FIG. 4 is an exploded perspective view illustrating a configuration of a sensing unit of a non-contact temperature monitoring device according to an exemplary embodiment of the present invention;

FIG. 5 is a cross-sectional view illustrating an operation principle of a sensing unit of a non-contact temperature monitoring device according to an exemplary embodiment of the present invention;

FIGS. 6 and 7 are diagrams illustrating a temperature detection point setting method of a non-contact temperature detection unit according to an exemplary embodiment of the present invention;

FIG. 8 is a cross-sectional view illustrating a front and rear moving state of a lens module of a non-contact temperature detection unit according to an exemplary embodiment of the present invention; and

FIG. 9 is a perspective view illustrating an installation form of a sensing unit according to an exemplary embodiment of the present invention.

### BEST MODES FOR CARRYING OUT THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

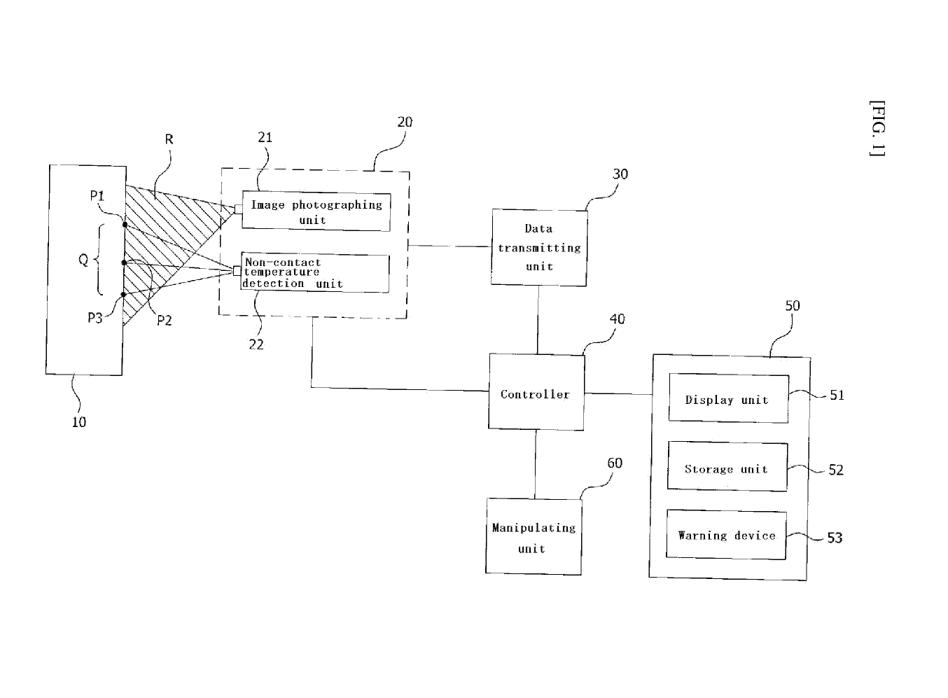

FIG. 1 is a block diagram illustrating a configuration of a non-contact temperature monitoring device according to an exemplary embodiment of the present invention.

The non-contact temperature monitoring device according to an exemplary embodiment of the present invention is a device that photographs and monitors a temperature detection object 10 while detecting a temperature of a plurality of points of the temperature detection object 10 with a non-contact method and includes a sensing unit 20, a data transmitting unit 30, a monitoring unit 50, and a controller 40.

The sensing unit 20 includes a non-contact temperature detection unit 22 and an image photographing unit 21, the non-contact temperature detection unit 22 is formed to detect a temperature of a plurality of points of the temperature detection object 10 with a non-contact method, and the image photographing unit 21 is formed to photograph the temperature detection object 10. In this case, as shown in FIG. 1, the non-contact temperature detection unit 22 is formed to detect a temperature of specific points P1, P2, and P3 in a range within a photographing area R photographed by the image photographing unit 21.

The image photographing unit 21 may be formed in a form including a camera 21a that photographs an image, and the non-contact temperature detection unit 22 may be formed to detect a plurality of temperatures of a specific point corresponding to a photographing image of such an image photographing unit 21 and a detailed description thereof will be described later.

The data transmitting unit 30 is formed to transmit temperature data and image data obtained through the non-contact temperature detection unit 22 and the image photographing unit 21 of the sensing unit 20 to the controller 40. Such a data transmitting unit 30 is connected to the sensing unit 20 and the controller 40 with a wireless or wired method to transmit data.

The controller 40 receives temperature data and image data from the data transmitting unit 30 to apply the temperature data and the image data to a monitoring unit 50, and the monitoring unit 50 receives such data to output the data in real time.

The monitoring unit 50 includes a display unit 51 that displays temperature data and image data received from the controller 40 and a warning device 53 that can warn a state of temperature data received from the controller 40 and further includes a storage unit 52 that can store temperature data and image data received from the controller 40.

The display unit 51 may be formed with a liquid crystal display device so as to display temperature data and image data, and the storage unit 52 is a device that can store temperature data and image data in real time and may be formed with a separate memory device. Such a display unit 51 and storage unit 52 may be embodied with one computer main body and monitor device. The warning device 53 may be formed with a device that can send a warning signal to a user through a hearing and visual signal such as an alarm bell or a light bar. In this case, if temperature data obtained by the non-contact temperature detection unit 22 is equal to or larger than a preset reference value, the controller 40 controls the warning device 53 to operate.

The non-contact temperature monitoring device according to an exemplary embodiment of the present invention may be formed so that the image photographing unit 21 of the sensing unit 20 may selectively operate only in a specific mode, and for this purpose, in order to select an operation state of the image photographing unit 21, a separate manipulating unit 60 manipulated by a user may be provided. The manipulating unit 60 may be formed to turn on/off an operation state of the image photographing unit 21, and the controller 40 is formed to control an operation state of the image photographing unit 21 according to a manipulating signal of such a manipulating unit 60.

That is, when an operation state of the image photographing unit 21 is manipulated to an on state by the manipulating unit 60, the controller 40 operates the image photographing unit 21, and thus image data is generated to be applied to the monitoring unit 50 through the controller 40. However, if an operation state of the image photographing unit 21 is manipulated to an off state by the manipulating unit 60, the controller 40 stops operation of the image photographing unit 21, and thus generation of image data is stopped and thus only temperature data by the non-contact temperature detection unit 22 is applied to the monitoring unit 50.

In other words, the image photographing unit 21 is formed to operate by a user's manipulation through the manipulating unit 60, and only during a period in which the image photographing unit 21 operates, image data is generated and applied to the monitoring unit 50. Therefore, in this case, both temperature data and image data are output through the monitoring unit 50. However, during a period in which the image photographing unit 21 does not operate, because image data is not generated, only temperature data of the non-contact temperature detection unit 22 is applied to the monitoring unit 50. Therefore, in this case, only temperature data is output through the monitoring unit 50.

The controller 40 controls the image photographing unit 21 to selectively operate by a specific condition in addition to a selective operation by a manipulation of such a manipulating unit 60, and according to an exemplary embodiment of the present invention, the controller 40 may control to operate according to temperature data obtained by the non-contact temperature detection unit 22.

For example, if temperature data obtained by the non-contact temperature detection unit 22 is equal to or larger than a preset reference value, the image photographing unit 21 operates and the controller 40 controls the image photographing unit 21 to photograph the temperature detection object 10. That is, if a temperature of the temperature detection object 10 detected by the non-contact temperature detection unit 22 is smaller than a reference value, a temperature of the temperature detection object 10 is within a normal range and thus the non-contact temperature detection unit 22 operates with a method of continuing to measure and monitor a temperature of the temperature detection object 10, and if a temperature of a specific point of the temperature detection object 10 detected by the non-contact temperature detection unit 22 is equal to or larger than a reference value, it represents that an abnormal situation occurs at a corresponding point and thus in this case, the image photographing unit 21 photographs the temperature detection object 10 and outputs a photographing image through the monitoring unit 50.

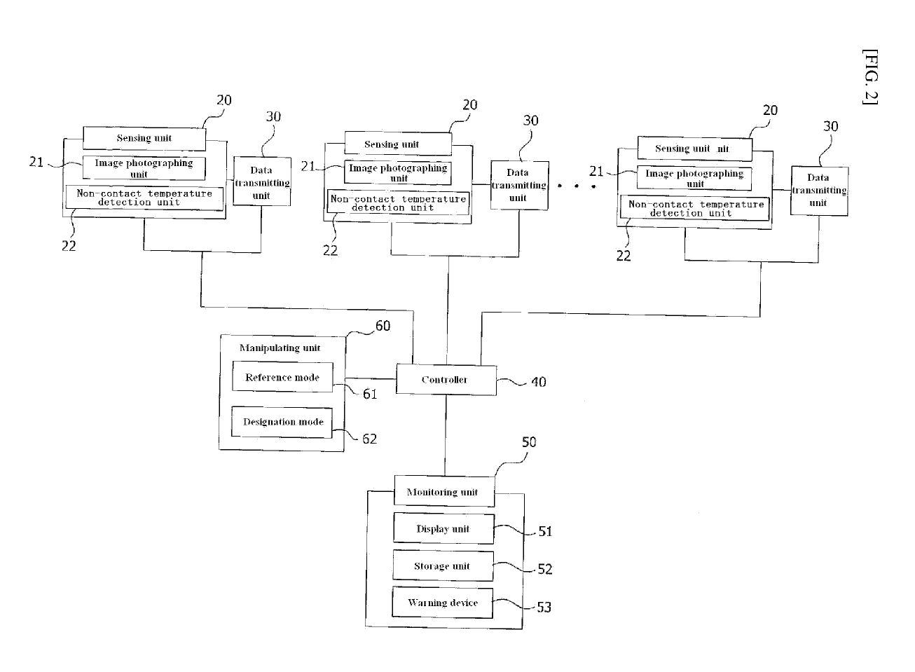

FIG. 2 is a block diagram illustrating a configuration of another form of a non-contact temperature monitoring device according to an exemplary embodiment of the present invention.

The non-contact temperature monitoring device according to an exemplary embodiment of the present invention may be formed to monitor a plurality of temperature detection objects 10. For this purpose, as shown in FIG. 2, the sensing unit 20 and the data transmitting unit 30 corresponding thereto are each provided in plural, and the controller 40 may control operation of a plurality of sensing units 20 and monitoring units 50. In this case, the controller 40 may control to alternately output temperature data of a plurality of sensing units 20 to the monitoring unit 50 and thus all of a plurality of temperature detection objects 10 by the plurality of sensing units 20 may be monitored in real time.

As described above, the manipulating unit 60 manipulated by a user may be formed to select an operation state of the image photographing unit 21 and may be formed to select an operation state of the monitoring unit 50 to a reference mode 61 and a designation mode 62. In a state of the reference mode 61, as described above, temperature data of the plurality of sensing units 20 are alternately output to the monitoring unit 50, and in a state of the designation mode 62, temperature data of the specific sensing unit 20 in which the user designates are output to the monitoring unit 50.

Further, if one temperature data of temperature data of the plurality of sensing units 20 is equal to or larger than a preset reference value, the controller 40 controls the image photographing unit 21 of the corresponding sensing unit 20 to operate and controls to continuously and intensively output temperature data and image data of the corresponding sensing unit 20 to the monitoring unit 50.

That is, in any one of a plurality of temperature detection objects 10, if a temperature rises a reference value or more, temperature data of the sensing unit 20 corresponding to a corresponding temperature detection object 10 rises a reference value or more, and the controller 40 detects this and controls the image photographing unit 21 of the corresponding sensing unit 20 to operate. As the image photographing unit 21 of the corresponding sensing unit 20 operates, temperature data and image data from the corresponding sensing unit 20 are transmitted to the controller 40 through the data transmitting unit 30, and the controller 40 controls operation of the monitoring unit 50 so that such temperature data and image data continuously and intensively output to the display unit 51 of the monitoring unit 50.

Therefore, in a specific temperature detection object 10, when a temperature rises according to an abnormal situation, temperature data and image data of the corresponding temperature detection object 10 are intensively output to the display unit 51 of the monitoring unit 50, and thus the user can recognize rapidly and accurately an emergency situation of the corresponding temperature detection object 10. In this case, the warning device 53 of the monitoring unit 50 will continually operate.

According to such a configuration, the non-contact temperature monitoring device according to an exemplary embodiment of the present invention may continue to monitor a temperature change state of a plurality of temperature detection objects 10 in real time, and when an abnormal situation in which a temperature increases in the temperature detection object 10 occurs, an image of the corresponding temperature detection object 10 is output in real time and thus an field situation can be more accurately grasped through image information and thus a necessary action can be more rapidly performed.

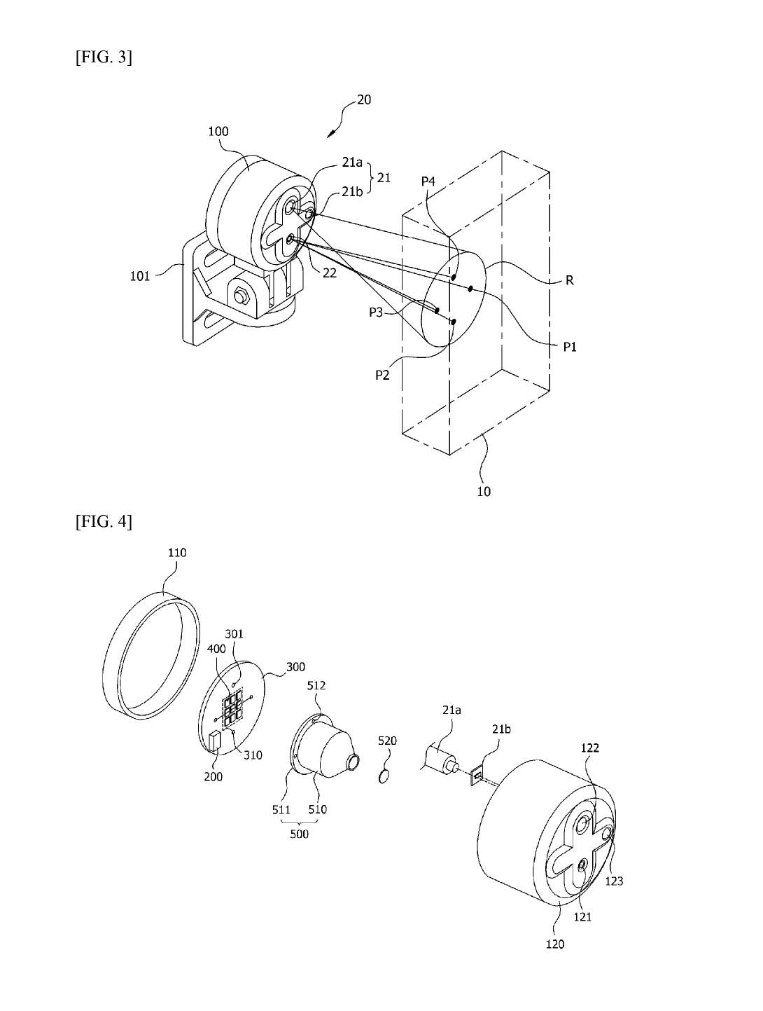

Hereinafter, a configuration of a sensing unit of a non-contact temperature monitoring device according to an exemplary embodiment of the present invention will be described in detail with reference to FIGS. 3 to 8.

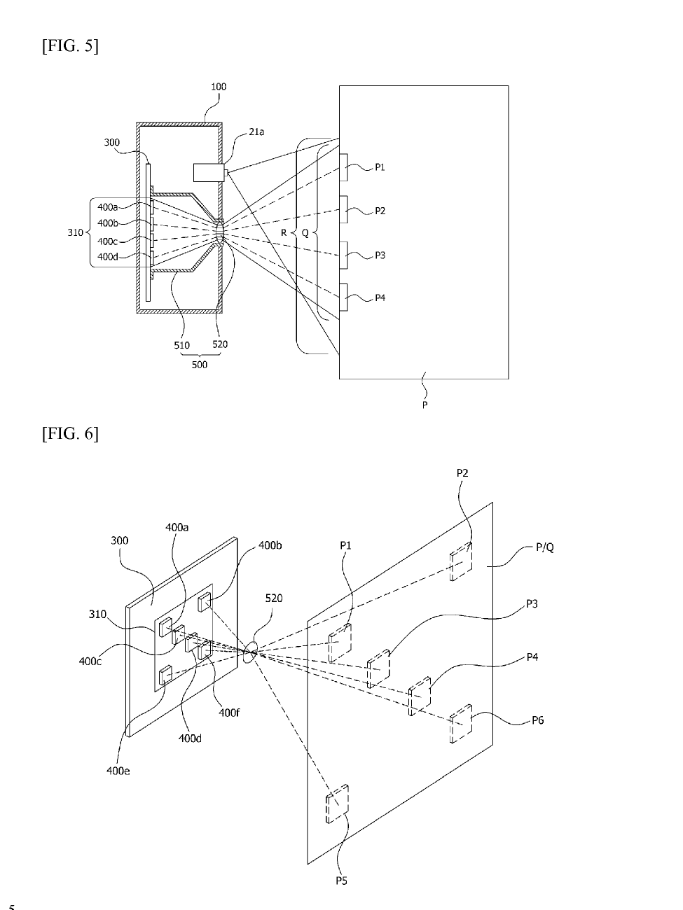

FIG. 3 is a perspective view illustrating a shape of a sensing unit of a non-contact temperature monitoring device according to an exemplary embodiment of the present invention, FIG. 4 is an exploded perspective view illustrating a configuration of a sensing unit of a non-contact temperature monitoring device according to an exemplary embodiment of the present invention, and FIG. 5 is a cross-sectional view illustrating an operation principle of a sensing unit of a non-contact temperature monitoring device according to an exemplary embodiment of the present invention.

As shown in FIG. 3, the sensing unit 20 according to an exemplary embodiment of the present invention is fixed and coupled to be separated from one case 100 so that a relative position of the non-contact temperature detection unit 22 and the image photographing unit 21 is fixed. In this case, one case 100 is coupled to adjust an angle to a separate fixed bracket 101 and is mounted to adjust a temperature detection point of the non-contact temperature detection unit 22 or a photographing area of the image photographing unit 21.

In this case, the non-contact temperature detection unit 22 is formed to detect a temperature of a plurality of points P1, P2, P3, and P4 within a photographing area R photographed by the image photographing unit 21 and thus detects a temperature of a specific point corresponding to an image photographed by the image photographing unit 21.

In more detail, as shown in FIG. 4, in order to form receiving space therein, the case 100 is divided into a case main body 110 and a case cover 120, and in the case cover 120, a plurality of through-holes 121,122, and 123 are formed to protrude and couple the non-contact temperature detection unit 22 and the image photographing unit 21 to the front side.

The image photographing unit 21 includes a camera 21a coupled to the case 100 to photograph the temperature detection object 10 and a lighting lamp 21b coupled to the case 100 to radiate lighting light to the front side of the camera, and the controller 40 controls operation of the camera 21a and the lighting lamp 21b, as described above. In this case, it is preferable that as the lighting lamp 21b, a Light Emitting Diode (LED) lamp is applied. Because general various camera 21a and lighting lamp 21b may be used, a detailed description of such an image photographing unit 21 will be omitted.

A non-contact temperature detection unit is a device that can measure a temperature of a plurality of points of a temperature detection object P with a non-contact method and includes a printed circuit board (PCB) 300, a lens module 500, an infrared ray sensor chip 400, and a calculation unit 200.

The PCB 300 is fixedly mounted in the main body 110 so as to dispose at inside space of the case 100, and a light receiving area 310 is formed at one side of a component mounting surface. The light receiving area 310 is a receiving area of infrared rays, having passed through the lens module 500, and the lens module 500 is coupled to the PCB 300 in a form that receives such a light receiving area 310 therein.

The lens module 500 collects infrared rays generated in the temperature detection object P and is disposed to protrude the through-hole 121 of the case cover 120 so as to apply light to the light receiving area 310 of the PCB 300. Such a lens module 500 may be formed with a lens barrel 510 and a lens 520 mounted in the lens barrel 510, as shown in FIG. 4.

The lens barrel 510 is space that passes through infrared rays applied through the lens 520 and is made of an opaque material so that external light is not injected into the lens barrel 510. Therefore, the lens barrel 510 may be formed in a hollow cylindrical form or polygonal pillar form, and at the front side surface, in order to insert and couple the lens 520, the lens barrel 510 is formed in an opened form. Such a lens barrel 510 is mounted in the PCB 300 so that one end thereof encloses the light receiving area 310 of the PCB 300, and the other end thereof is disposed to protrude to a front side surface of the case 100, and the lens 520 is coupled to the other end of such a lens barrel 510.

In this case, a flange portion 511 is formed at one end of the lens barrel 510, and a coupling hole 512 for coupling to the PCB 300 is formed to the flange portion 511. A fixing tab 301 is formed in the PCB 300 to correspond thereto, and such a fixing tab 301 is formed to position at the outside of the light receiving area 310. Therefore, the lens barrel 510 may be mounted in the PCB 300 with a method of screw coupling a separate coupling screw (not shown) that penetrates the coupling hole 512 to the fixing tab 301, and in this case, it is preferable to couple to seal without a separation gap so that external light is not applied to internal space of the lens barrel 510 or the light receiving area 310 through a coupling region of the lens barrel 510 and the PCB 300. In order to intercept such light, a separate interception member (not shown) having an elastic force may be mounted in the flange portion 511 of the lens barrel 510.

As the lens 520, a lens for a general camera may be used, and in order to apply infrared rays in a more wide area to the light receiving area 310, the lens 520 performs a function of focusing light. Therefore, it is preferable that a convex lens is used for focusing light, and in order to more accurately and variously adjust a path of light arriving in the light receiving area 310, a plurality of various lens may be further mounted.

The infrared ray sensor chip 400 is mounted in plural in the light receiving area 310 of the PCB 300 so as to receive infrared rays applied through the lens module 500. Such an infrared ray sensor chip 400 is an electronic chip that receives infrared rays and converts the infrared rays to an electric signal and is formed to generate a voltage of different magnitudes according to a quantity of received infrared rays.

The calculation unit 200 is an element that generates a temperature value by receiving and calculating an electric signal of the infrared ray sensor chip 400 and may be connected to the infrared ray sensor chip 400 through a pattern circuit of the PCB 300 in a form of a separate electric chip mounted in the PCB 300, as shown in FIG. 4.

In such an infrared ray sensor chip 400 and calculation unit 200, a light electric signal having different voltages in the infrared ray sensor chip 400 is generated according to a light receiving quantity of infrared rays received in the infrared ray sensor chip 400, and the calculation unit 200 is formed with a method of calculating a corresponding temperature value by correcting and calculating such an electric signal. Such a configuration is a configuration widely used for a general infrared ray sensor for measuring a temperature of a corresponding object using a principle in which infrared rays of different quantities are emitted according to a temperature in an entire object and a detailed description thereof will be omitted.

The non-contact temperature detection unit 22 according to an exemplary embodiment of the present invention may detect a temperature of a plurality of points of a relatively wide temperature detection target area Q according to such a structure. That is, as shown in FIG. 1, in the temperature detection target area Q of an area relatively wider than a size of the lens module 500, infrared rays are applied to the light receiving area 310 through the lens module 500, and each of a plurality of infrared ray sensor chips 400 mounted in the light receiving area 310 receives infrared rays, and a temperature of a plurality of points of a corresponding temperature detection target area Q may be detected through such a plurality of infrared ray sensor chips 400.

In other words, infrared rays generated in a plurality of points within the temperature detection target area Q are received in a plurality of infrared ray sensor chips 400, respectively, mounted in the light receiving area 310, thereby detecting a temperature of each of a plurality of points of the temperature detection target area Q. In this case, the temperature detection target area Q may correspond to a partial area of the temperature detection object P and correspond to an area including an entire area of the temperature detection object P. This may be adjusted according to a separation distance between the non-contact temperature detection unit 22 and the temperature detection object P. Further, it is preferable that such a temperature detection target area Q is limited to a range within a photographing area R of the image photographing unit 21.

FIG. 5 is a cross-sectional view illustrating an operation principle of the non-contact temperature detection unit 22, and hereinafter, an operation principle of the non-contact temperature detection unit 22 according to an exemplary embodiment of the present invention will be described in detail with reference to FIG. 5.

First, in the non-contact temperature detection unit 22 according to an exemplary embodiment of the present invention, infrared rays of the temperature detection target area Q of a relatively wide size like a general camera are focused through the lens module 500 to be applied to the light receiving area 310 of the PCB 300. In this case, because an incident path of infrared rays changes according to a kind of the lens 520 of the lens module 500, by changing a kind of the lens 520, a size of the temperature detection target area Q that can detect may be changed. Further, by changing a separation distance between the non-contact temperature detection unit 22 and the temperature detection object P, a size of the temperature detection target area Q that can detect may be changed.

In this case, in the light receiving area 310 of the PCB 300, a plurality of infrared ray sensor chips 400a, 400b, 400c, and 400d are mounted, and infrared rays generating at points P1, P2, P3, and P4 corresponding to the infrared ray sensor chips 400a, 400b, 400c, and 400d along an infrared ray incident path are received in the infrared ray sensor chips 400a, 400b, 400c, and 400d, respectively. Each of the points P1, P2, P3, and P4 corresponds to some area belonging to the inside of the temperature detection target area Q, and as shown in FIG. 5, the temperature detection target area Q is set to correspond to a partial area of the temperature detection object P to detect a temperature, as shown in FIG. 5, and it is preferable that the temperature detection target area Q is set to correspond to a partial area within the photographing area R of the image photographing unit 21.

In this way, when infrared rays of a plurality of points P1, P2, P3, and P4 within the temperature detection target area Q are received in each of the infrared ray sensor chips 400a, 400b, 400c, and 400d, infrared ray emitting amounts are different according to a temperature of each of the points P1, P2, P3, and P4 and thus electric signals generated in each of the infrared ray sensor chips 400a, 400b, 400c, and 400d are differently generated and thus a temperature of a corresponding point is calculated through the calculation unit 200.

Therefore, as the non-contact temperature detection unit 22 according to an exemplary embodiment of the present invention disposes a plurality of infrared ray sensor chips 400a, 400b, 400c, and 400d within the light receiving area 310, the non-contact temperature detection unit 22 may detect a temperature of a plurality of points P1, P2, P3, and P4 of the temperature detection object P, and by variously changing a disposition state of the infrared ray sensor chips 400a, 400b, 400c, and 400d within the light receiving area 310, a position of corresponding plurality of points P1, P2, P3, and P4 may be variously changed. That is, by changing a disposition state of the infrared ray sensor chips 400a, 400b, 400c, and 400d, corresponding points P1, P2, P3, and P4 of the temperature detection target area Q corresponding thereto are changed according to an incident path of infrared rays and thus by changing a disposition state of the infrared ray sensor chips 400a, 400b, 400c, and 400d according to a kind of the temperature detection object P, a temperature of a specific point of various temperature detection objects P may be detected.

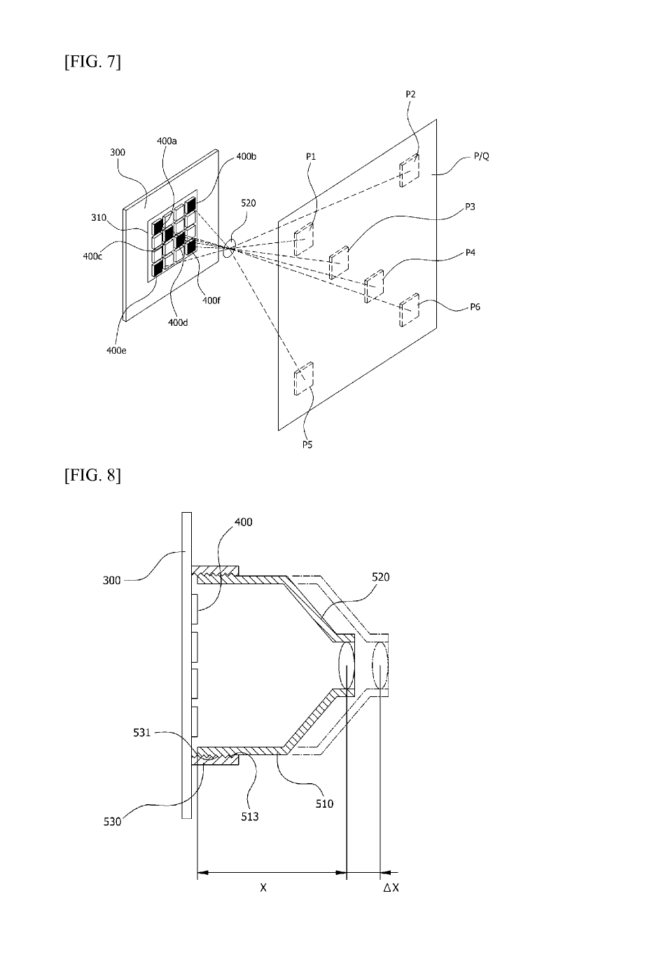

FIGS. 6 and 7 are diagrams illustrating a temperature detection point setting method of a non-contact temperature detection unit according to an exemplary embodiment of the present invention.

As shown in FIG. 5, as the non-contact temperature detection unit 22 according to an exemplary embodiment of the present invention changes a disposition state of a plurality of infrared ray sensor chips 400 disposed within the light receiving area 310, a temperature of various specific points of the temperature detection object P may be detected.

For example, as shown in FIG. 6, when wanting to detect a temperatures of six specific points P1, P2, P3, P4, P5, and P6 within the temperature detection object P or the temperature detection target area Q, by disposing six infrared ray sensor chips 400a, 400b, 400c, 400d, 400e, and 400f at positions corresponding to six specific points P1, P2, P3, P4, P5, and P6 along a path in which infrared rays are applied within the light receiving area 310, a temperature of a corresponding specific point may be detected. As described above, because infrared rays generated in six specific points P1, P2, P3, P4, P5, and P6 are received in six infrared ray sensor chips 400a, 400b, 400c, 400d, 400e, and 400f, respectively, at each point, a temperature can be detected.

Temperature detection of a specific point of such a temperature detection object P may be performed with a method shown in FIG. 7. That is, a plurality of infrared ray sensor chips 400 are evenly disposed in an entire area within the light receiving area 310, and temperature detection may be performed with a method of activating only specific infrared ray sensor chips 400a, 400b, 400c, 400d, 400e, and 400f of the plurality of infrared ray sensor chips 400. In this case, as described above, the activated specific infrared ray sensor chips 400a, 400b, 400c, 400d, 400e, and 400f correspond to an infrared ray sensor chip positioned at a position corresponding to specific points P1, P2, P3, P4, P5, and P6 to detect a temperature within the temperature detection object P or the temperature detection target area Q.

Such an activation method may be performed with a method of mounting a separate switch (not shown) that supplies and intercepts power to each infrared ray sensor chip 400 on the PCB 300 and may be performed with a change of a pattern circuit of the PCB 300 or other various methods.

In other words, a method shown in FIG. 6 is a method of detecting a temperature of a plurality of specific points with a method of disposing the infrared ray sensor chip 400 at a corresponding position within the light receiving area 310 with the infrared ray sensor chip 400 corresponding to the number of a specific point to detect a temperature, and a method shown in FIG. 7 is a method of detecting a temperature of a plurality of specific points with a method of activating only the infrared ray sensor chip 400 of a position corresponding to a specific point to detect a temperature in a state in which the infrared ray sensor chip 400 is disposed in an entire area within the light receiving area 310.

Therefore, the user can easily detect a temperature of a plurality of points of the temperature detection object P using an appropriate method according to a field situation or need.

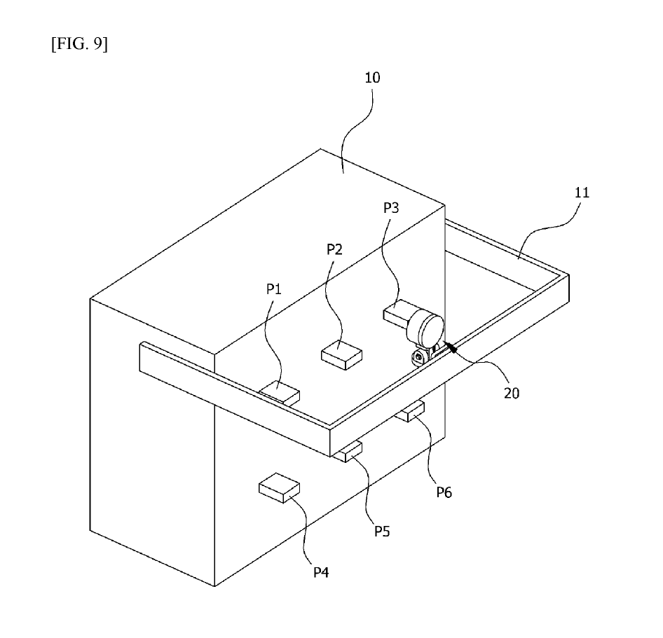

FIG. 8 is a cross-sectional view illustrating a front and rear moving state of a lens module of a non-contact temperature detection unit according to an exemplary embodiment of the present invention.

As described above, the lens module 500 according to an exemplary embodiment of the present invention includes the lens barrel 510 that encloses the light receiving area 310 and the lens 520 mounted in the lens barrel 510, and as shown in FIG. 4, the lens barrel 510 may be fixed and coupled to the PCB 300 with a screw coupling method, but alternatively, the lens barrel 510 may be coupled to move in a front-rear direction from the PCB 300.

A method of movably coupling the lens barrel 510 may be performed through a fixing device 530 in which a female screw thread 531 is formed at an inner circumferential surface. That is, the fixing device 530 of a ring form is mounted to enclose the light receiving area 310 in the PCB 300, and at an inner circumferential surface of the fixing device 530, the female screw thread 531 is formed. In this case, at an outer circumferential surface of one end portion of the lens barrel 510, in order to screw couple to the female screw thread 531 of the fixing device 530, a male screw thread 513 is formed, and by screw coupling the lens barrel 510 to the fixing device 530, the lens barrel 510 may move in the front-rear direction. That is, by rotating the lens barrel 510 clockwise or counterclockwise, the lens barrel 510 moves in the front-rear direction along a screw thread of the fixing device 530.

In this way, when the lens barrel 510 moves in the front-rear direction, as shown in FIG. 8, a separation distance X between the infrared ray sensor chip 400 mounted in the light receiving area 310 and the lens 520 mounted in the lens barrel 510 changes. When such a separation distance X changes by ΔX, a moving path segment of infrared rays received in the infrared ray sensor chip 400 changes, and thus a position of a temperature detection point in which a temperature is detected by the infrared ray sensor chip 400 is changed.

Therefore, the non-contact temperature detection unit 22 according to an exemplary embodiment of the present invention can minutely change and correct a position of a corresponding temperature detection point through a position change of such a lens barrel 510. For example, while using, when a change occurs in a temperature detection point or when a temperature of an accurate point is not detected due to damage of the lens 520, a position of a corresponding temperature detection point may be corrected through movement of such a lens barrel 510.

FIG. 9 is a perspective view illustrating an installation form of a sensing unit according to an exemplary embodiment of the present invention.

As shown in FIG. 9, the non-contact temperature detection unit according to an exemplary embodiment of the present invention is applied to a switchboard P widely used in an industry field for a temperature detection object to detect a temperature of a plurality of points of the switchboard P.

In the switchboard P, in order to transmit and receive power, a plurality of contact point positions P1, P2, P3, P4, P5, and P6 exist, and at such a contact point position, a heat frequently occurs due to increase of electric resistance. Therefore, in order to receive entire infrared rays generated at such contact point positions P1, P2, P3, P4, P5, and P6, the sensing unit 20 may be fixed and mounted through a separate fixed frame 11 at the upper portion side of the switchboard P.

In the sensing unit 20 mounted in this way, the non-contact temperature detection unit 22 is installed to apply entire infrared rays of a plurality of contact point positions P1, P2, P3, P4, P5, and P6 through the lens module 500, and a temperature of a corresponding position may be detected in real time through the infrared ray sensor chip 400 corresponding to each of contact point positions P1, P2, P3, P4, P5, and P6. Further, the image photographing unit 21 is formed to photograph an area including each of the contact point positions P1, P2, P3, P4, P5, and P6, and when an abnormal situation such as temperature increase at a specific contact point occurs, the image photographing unit 21 is controlled to photograph this.

In this way, temperature data and image data of each contact point position obtained through the non-contact temperature detection unit 22 and the sensing unit 20 are transmitted to the controller 40 through the data transmitting unit 30 and are applied from the controller 40 to the monitoring unit 50 to be output by the monitoring unit 50.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

1. A non-contact temperature monitoring device, comprising:
a non-contact temperature detection unit that detects a temperature of a plurality of points of a temperature detection object with a non-contact method;
a sensing unit that comprises an image photographing unit that photographs the temperature detection object;
a data transmitting unit that is connected to the sensing unit to transmit temperature data and image data obtained by the sensing unit;
a monitoring unit that receives and outputs temperature data and image data obtained by the sensing unit; and
a controller that receives the temperature data and the image data from the data transmitting unit to apply the temperature data and the image data to the monitoring unit.

2. The non-contact temperature monitoring device of claim 1, further comprising a manipulating unit to be manipulated by a user so as to select an operation state of the image photographing unit, wherein the controller controls an operation state of the image photographing unit according to a manipulating signal of the manipulating unit.

3. The non-contact temperature monitoring device of claim 1, wherein the controller controls an operation state of the image photographing unit according to temperature data obtained by the non-contact temperature detection unit.

4. The non-contact temperature monitoring device of claim 3, wherein the controller controls the image photographing unit to photograph the temperature detection object, if temperature data obtained by the non-contact temperature detection unit is equal to or larger than a preset reference value.

5. The non-contact temperature monitoring device of claim 1, wherein the sensing unit and a data transmitting unit corresponding thereto are each provided in plural, and the controller controls to alternately output temperature data of a plurality of sensing units to the monitoring unit.

6. The non-contact temperature monitoring device of claim 5, wherein the controller controls an image photographing unit of a corresponding sensing unit to operate and controls temperature data and image data of a corresponding sensing unit to intensively output to the monitoring unit, if one temperature data of temperature data of the plurality of sensing units is equal to or larger than a preset reference value.

7. The non-contact temperature monitoring device of claim 1, wherein the monitoring unit comprises:
a display unit that displays temperature data and image data received from the controller; and
a warning device that can warn a state of temperature data received from the controller, wherein the controller controls the warning device to operate, if temperature data is equal to or larger than a preset reference value.

8. The non-contact temperature monitoring device of claim 1, wherein the non-contact temperature detection unit and the image photographing unit of the sensing unit are fixed and coupled to one case so as to fix a relative position.

9. The non-contact temperature monitoring device of claim 8, wherein the non-contact temperature detection unit detects a temperature of a plurality of points within an area photographed by the image photographing unit.

10. The non-contact temperature monitoring device of claim 9, wherein the non-contact temperature detection unit comprises:
a printed circuit board (PCB) that is disposed within the case and that has a light receiving area at one side;
a lens module that collects infrared rays generated in the temperature detection object and that is mounted to protrude to a front side surface of the case so as to apply the infrared rays to the light receiving area;
an infrared ray sensor chip that is mounted in plural in the light receiving area so as to receive infrared rays and that receives infrared rays to convert the infrared rays to an electric signal; and
a calculation unit that receives and calculates an electric signal of the infrared ray sensor chip to generate each temperature data, wherein a temperature of a plurality of points of the temperature detection object is detected through a plurality of infrared ray sensor chips.

11. The non-contact temperature monitoring device of claim 10, wherein the image photographing unit comprises:
a camera that is coupled to the case to photograph the temperature detection object; and
a lighting lamp that is coupled to the case to radiate lighting light to the front side of the camera, wherein the controller controls the camera and the lighting lamp to operate.

12. The non-contact temperature monitoring device of claim 10, wherein the infrared ray sensor chip is disposed in a specific arrangement state in the light receiving area so as to detect a temperature of a specific point of the temperature detection object.

13. The non-contact temperature monitoring device of claim 10, wherein the infrared ray sensor chip is evenly disposed in an entire area of the light receiving area, and only a specific infrared ray sensor chip of a plurality of infrared ray sensor chips is activated to detect only a temperature of a specific point of the temperature detection object.

14. The non-contact temperature monitoring device of claim 2, wherein the monitoring unit comprises:
a display unit that displays temperature data and image data received from the controller; and
a warning device that can warn a state of temperature data received from the controller, wherein the controller controls the warning device to operate, if temperature data is equal to or larger than a preset reference value.

15. The non-contact temperature monitoring device of claim 3, wherein the monitoring unit comprises:
a display unit that displays temperature data and image data received from the controller; and
a warning device that can warn a state of temperature data received from the controller, wherein the controller controls the warning device to operate, if temperature data is equal to or larger than a preset reference value.

16. The non-contact temperature monitoring device of claim 4, wherein the monitoring unit comprises:
a display unit that displays temperature data and image data received from the controller; and
a warning device that can warn a state of temperature data received from the controller, wherein the controller controls the warning device to operate, if temperature data is equal to or larger than a preset reference value.

17. The non-contact temperature monitoring device of claim 5, wherein the monitoring unit comprises:
a display unit that displays temperature data and image data received from the controller; and
a warning device that can warn a state of temperature data received from the controller, wherein the controller controls the warning device to operate, if temperature data is equal to or larger than a preset reference value.

18. The non-contact temperature monitoring device of claim 6, wherein the monitoring unit comprises:
a display unit that displays temperature data and image data received from the controller; and
a warning device that can warn a state of temperature data received from the controller, wherein the controller controls the warning device to operate, if temperature data is equal to or larger than a preset reference value.

19. The non-contact temperature monitoring device of claim 2, wherein the non-contact temperature detection unit and the image photographing unit of the sensing unit are fixed and coupled to one case so as to fix a relative position.

20. The non-contact temperature monitoring device of claim 3, wherein the non-contact temperature detection unit and the image photographing unit of the sensing unit are fixed and coupled to one case so as to fix a relative position.

21. The non-contact temperature monitoring device of claim 4, wherein the non-contact temperature detection unit and the image photographing unit of the sensing unit are fixed and coupled to one case so as to fix a relative position.

22. The non-contact temperature monitoring device of claim 5, wherein the non-contact temperature detection unit and the image photographing unit of the sensing unit are fixed and coupled to one case so as to fix a relative position.

23. The non-contact temperature monitoring device of claim 6, wherein the non-contact temperature detection unit and the image photographing unit of the sensing unit are fixed and coupled to one case so as to fix a relative position.
